(19) United States
(12) Patent Application Publication
(10) Pub. No.: US 2012/0197445 A1
(43) Pub. Date: Aug. 2, 2012

(54) AIR-CONDITIONER OPERATION CONTROLLING DEVICE AND METHOD

(75) Inventors: Kimihiko Yoshida, Tokyo (JP); Hiroshi Noguchi, Tokyo (JP)

(73) Assignee: YAMATAKE CORPORATION, Tokyo (JP)

(21) Appl. No.: 13/356,727

(22) Filed: Jan. 24, 2012

(30) Foreign Application Priority Data
Jan. 31, 2011 (JP) 2011-017606

(51) Int. Cl. G05D 23/19

(52) U.S. Cl. 700/277

(57) ABSTRACT

An air-conditioner operation controlling device controls each individual air-conditioner in a server room wherein are disposed a plurality of server racks for containing servers and a plurality of air conditioners for cooling the server racks. The air-conditioner operation controlling device includes an air-conditioning load calculating portion calculating air-conditioning loads of zones handled by individual air-conditioners from electric current values of the individual server racks; and a controlling portion controlling each individual air-conditioner through outputting, to each individual air-conditioner, a return air temperature setting value, by calculating, for each individual air-conditioner, a return air temperature setting value so that the supply air temperature for each of the air-conditioners is no less than a specific value, based on the air-conditioning loads and on the maximum temperature differentials between the return air temperature and the supply air temperature for each individual air-conditioner.

### CROSS REFERENCE TO RELATED APPLICATIONS

The present application claims priority under 35 U.S.C. §119 to Japanese Patent Application No. 2011-017606, filed Jan. 31, 2011, which is incorporated herein by reference.

### FIELD OF THE INVENTION

The present invention relates to an air conditioner operation controlling device and method for suppressing and controlling a temperature setting so as to not excessively cool an air-conditioned space in a server room or data center wherein is disposed in plurality of server racks, for containing servers, and a plurality of air conditioners, for cooling the server racks.

### BACKGROUND

A CRAC (Computer Room Air Conditioner) is a high sensible heat-type package air-conditioner that is installed in a server room or data center that is equipped with a large number of server racks. In a server room, the air must be dispersed by the CRACs, and there must not be any areas wherein there is excessive movement of the air nor any “hot spots” (areas wherein heat accumulates). Moreover, the CRACs are installed in an optimized layout based on a constant heat load produced by the equipment in the server room. The warmed air from the server rack is exhausted into an exhaust plenum behind the ceiling of the server room (the space behind the ceiling). The CRACs draw in this warmed air (return air) from above, and cools the air that has been drawn in. The cold air (supply air) that has been cooled by the CRACs is expelled to a supply air plenum under the floor of the server room (the underfloor space), to be blown into the server room from the supply air plenum. The CRACs perform control so as to cause the supply air temperature to be constant, or to cause the return air temperature to be constant (See, for example, Japanese Unexamined Patent Application Publication 2009-140421).

In conventional control, the temperature setting value is unchanging, and thus when the setting value ceases to be appropriate depending on the air-conditioning load, the result will be an excessively cooled state, in consideration of safety, which is a problem in terms of the efficiency of energy consumption (COP) of the CRACs.

The present invention is to solve the problem set forth above, and the object thereof is to provide an air-conditioner operation controlling device and method able to improve the efficiency of energy use in the air-conditioner and to decrease the amount of energy consumption.

### SUMMARY

An air-conditioner operation controlling device in a server room wherein is disposed a plurality of server racks for containing servers and a plurality of air conditioners for cooling the server racks, includes air conditioning load calculating means for calculating air-conditioning loads for zones that handle the individual air-conditioners, based on the electric current values of the individual server racks; and controlling means for controlling the individual air-conditioners through calculating, from the air-conditioning load and the maximum temperature difference between the return air temperature and the supply air temperature for each individual air-conditioner, a return air temperature setting value, for each individual air-conditioner, such that the supply air temperature will be no less than a specific temperature for the individual air-conditioner, and outputting the return air temperature setting values to the individual air-conditioners.

Additionally, one example configuration of an air-conditioning operation controlling device according to the present example further includes outside air temperature acquiring means for acquiring information on the outside air temperature, where the controlling means determine a maximum temperature difference depending on the outside air temperature when calculating the return air temperature setting value for each individual air-conditioner.

Additionally, an air-conditioner operation controlling method according to the present examples includes a conditioning load calculating step for calculating air-conditioning loads for zones that handle the individual air-conditioners, based on the electric current values of the individual server racks; and a controlling step for controlling the individual air-conditioners through calculating, from the air-conditioning load and the maximum temperature difference between the return air temperature and the supply air temperature for each individual air-conditioner, a return air temperature setting value, for each individual air-conditioner, such that the supply air temperature will be no less than a specific temperature for the individual air-conditioner, and outputting the return air temperature setting values to the individual air-conditioners.

In the present example, the air-conditioning load is calculated for each individual zone, and the return air temperature setting value is calculated for each individual air-conditioner based on the air-conditioning loads, so as to control each individual air-conditioner, thus making it possible to prevent a state of excessive cooling and possible to increase the efficiency of energy consumption of each individual air-conditioner. The result is that the present example enables a decrease in the amount of energy consumed.

Moreover, the present example enables more appropriate control of each individual air-conditioner through determining a maximum temperature difference depending on the outside air temperature when calculating the return air temperature setting value for each individual air-conditioner.

### BRIEF DESCRIPTION OF THE DRAWINGS

FIG. 1 is a plan view diagram illustrating a configuration of a server room relating to an example of the invention.

FIG. 2 is a block diagram illustrating a configuration of an air-conditioner operation controlling device according to the example.

FIG. 3 is a flowchart illustrating the operation of an air-conditioner operation controlling device according to the example.

### DETAILED DESCRIPTION

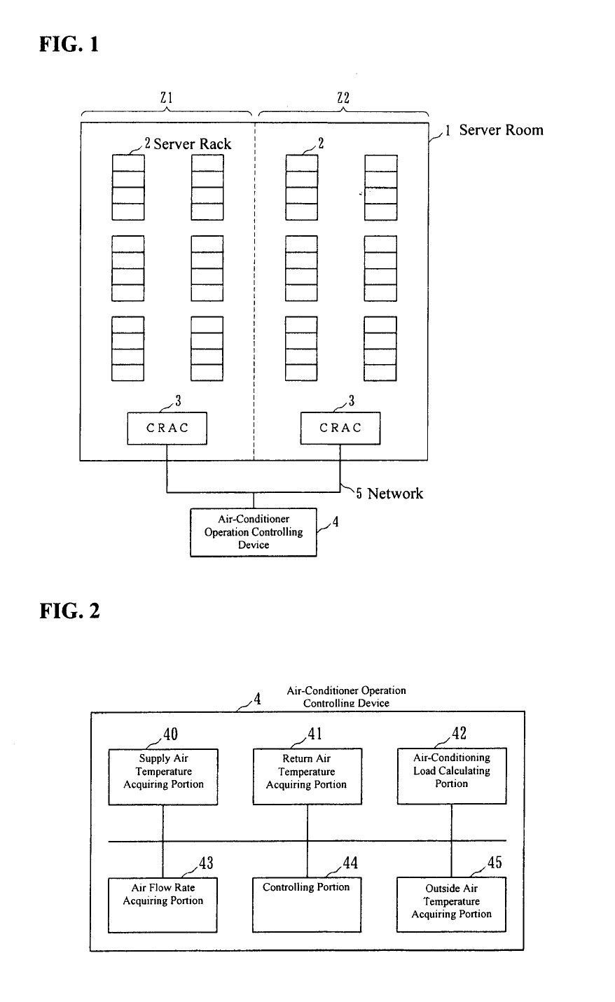

bean example is explained below in reference to the drawings. FIG. 1 is a plan view diagram illustrating an examples of a configuration of a server room. A plurality of server racks 2 and a plurality of CRACs 3 are disposed within the server room 1. As described above, the warm air from the individual server racks 2 is exhausted into an exhaust plenum (not shown) behind the ceiling in the server room 1. The supply air that is cooled by the CRACs 3 is expelled into a supply air plenum under the floor of the server room 1 and blown into the server room 1 from the supply air plenum.

In the present example, zones Z1 and Z2, which are separate regions of the server room 1 that are handled by the individual CRACs 3, are defined clearly. That is, there are clear definitions as to which server racks 2 have the cooling handled by the individual CRACs 3. These definitions are defined in advance by the designers depending on the disposal of the server racks 2 and the CRACs 3.

An air-conditioner operation controlling device 4 of the present example, for controlling a plurality of CRACs 3, is explained next. FIG. 2 is a block diagram illustrating a configuration of the air-conditioner operation controlling device 4. The air-conditioner operation controlling device 4 is structured from: a supply air temperature acquiring portion 40 for acquiring the temperature of the supply air that is exhausted from each individual CRAC 3; a return air temperature acquiring portion 41 for acquiring the temperature of the return air that is drawn into each individual CRAC 3; an air-conditioning load calculating portion 42 for calculating the air-conditioning loads of the zones Z1 and Z2 that are handled by the individual CRACs 3; an air flow rates acquiring portion 43 for acquiring air flow rate information for the individual CRACs 3; a controlling portion 44 for controlling the individual CRACs 3; and an outside air temperature acquiring portion 45 for acquiring the outside air temperature. The individual CRACs 3 and the air-conditioner operation controlling device 4 are connected together through a network 5.

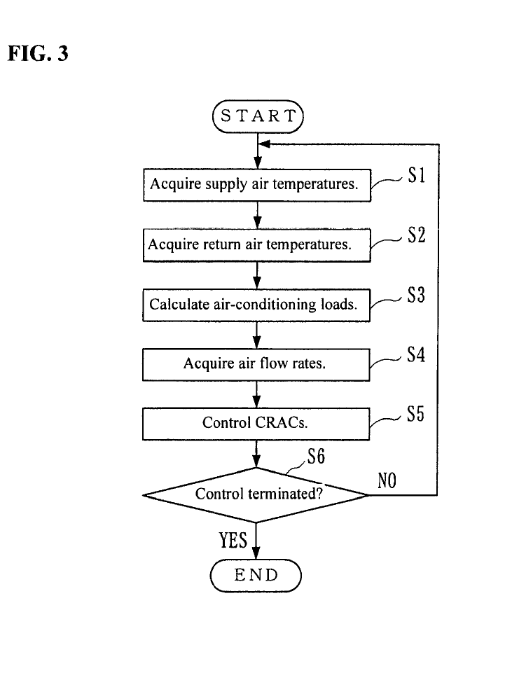

FIG. 3 is a flowchart illustrating the operation of the air-conditioner operation controlling device 4. The supply air temperature acquiring portion 40 acquires information on the supply air temperature through the network 5 from the individual CRACs 3 (Step S1 in FIG. 3). Each individual CRAC 3 expels the cooled supply air into the air supply plenum that is under the floor of the server room 1. A supply air temperature sensor, not shown, is provided under each individual CRAC 3. The supply air temperature acquiring portion 40 acquires the value for the air temperature measured by these supply air temperature sensors.

The return air temperature acquiring portion 41 acquires information for the return air temperature through the network 5 from each individual CRAC 3 (Step S2 in FIG. 3). Each CRAC 3 draws in return air from an exhaust plenum that is behind the ceiling of the server room 1. A supply air temperature sensor is disposed above each individual CRAC 3. The return air temperature acquiring portion 41 acquires the value of the return air temperature measured by each individual return air temperature sensor.

The air-conditioning load calculating portion 42 calculates, for each zone, the air-conditioning load of the zones Z1 and Z2 handled by the individual CRACs 3. The air-conditioning load calculating portion 42 acquires from a distribution board, not shown, or an ammeter, not shown, that is provided for each individual server rack 2, the value for the electric current for each server rack 2. As described above, the zone to which each individual server rack 2 belongs is defined in advance, and thus the air-conditioning load calculating portion 42 is able to aggregate the electric are values by the zone unit. After this, the air-conditioning load calculating portion 42 calculates, for each individual zone, the power consumption from the electric current values for the individual zones. In the case of server racks 2 that hold a plurality of servers, nearly all of the electric power that is consumed by each of the servers in the server rack 2 is converted into heat. Consequently, since it is possible to calculate, by the zone unit, the amount of electric power consumed, then it is possible to derive the air-conditioning load for each individual zone.

The air flow rate acquiring portion 43 acquires information on the air flow rates from each individual CRAC 3 to the network 5 (Step S4 in FIG. 3). Following this, the controlling portion 44 controls each individual CRAC 3 based on the supply air temperature acquired by the supply air temperature acquiring portion 40, the return air temperature acquiring by the return air temperature acquiring portion 41, the air-conditioning loads calculated by the air-conditioning load calculating portion 42, and the air flow rates acquired by the air flow rate acquiring portion 43 (Step S5 in FIG. 3).

In the explanation below, each CRAC 3 is assumed to be a constant-flow-rate air-conditioner, where the cooling capacity RT of each CRAC 3 is 50 kW, and the maximum temperature difference between the return air and the supply air (the input/output maximum temperature difference) AT in each individual CRAC 3 is assumed to be 10° C. The controlling portion 44 calculates the return air temperature setting value RAT of the CRAC 3 that handles the zone Z1 as follows when the reference supply air setting value SAT is 20° C. and the air-conditioning load L of the zone Z1 is 50 kW:

RAT=URT×ΔT+SAT=50 kW/50 kW×10° C.+20° C.=30° C. (1)

Moreover, the controlling portion 44 calculates the return air temperature setting value RAT for the CRAC 3 that handle the zone Z2 as follows when the air-conditioning load L of the zone Z2 is 25 W:

RAT=L/RT×ΔT+SAT=25 kW/50 kW×10° C.+20° C.=25° C. (2)

In this way, the controlling portion 44 is able to calculate, for each individual CRAC (that is, for each individual zone), the return air temperature setting value RAT so that the supply air temperature for each individual CRAC 3 is not be below a specific value. Moreover, the controlling portion 44 outputs, to the corresponding CRACs 3, the supply air temperature setting value SAT and the return air temperature setting values RAT that were calculated for the individual CRACs. Each individual CRAC 3 cools the return air so as to cause the return air temperature, measured by the return air temperature sensor, to match the return air temperature setting value RAT that was outputted from the air-conditioner operation controlling device 4, and so as to cause the supply air temperature, measured by the supply air temperature sensor, to match the supply air temperature setting value SAT outputted from the air-conditioner operation controlling device 4.

The air-conditioner operation controlling device 4 performs the processes in Step S1 through S5, described above, at regular time intervals until the air-conditioning control of the server room 1 is terminated (YES in Step S6 and FIG. 3). As described above, in the present example, the air-conditioning load is calculated for each individual zone, and the return air temperature setting value is calculated for each individual CRAC based on the air-conditioning loads, to thereby control the CRACs, thus making it possible to prevent an over cooling situation, enabling an increase in the operating efficiency of each individual CRAC.

Conventionally, in a supply air plenum, the supply air flow volumes from a plurality of CRACs is mixed, so the zones handled by the individual CRACs are unclear. In the present example, the zones handled by the individual CRACs are defined clearly, the correspondence relationships between the CRACs and the server racks are clearly defined, and the air-conditioning loads (the IT loads) handled by the individual CRACs are understood, making it possible to suppress and control the temperature settings so that there is no excessive cooling of the air-conditioned space.

Note that while in the present example the maximum temperature differential ΔT between the return air temperature and the supply air temperature in a CRAC is a fixed value, this may instead be varied depending on the outside air temperature. The reason for this is because the cooling and heating capacity of the CRAC varies depending on the outside air temperature. The outside air temperature acquiring portion 45 either acquires information on the outside air temperature from an outside air temperature sensor, not shown, or acquires information on the outside air temperature from a weather forecasting agency.

The controlling portion 44 determines the maximum temperature differential ΔT depending on the outside air temperature when calculating the return air temperature setting value RAT for each individual CRAC 3 in Step S5 in FIG. 3. The relationship between the outside air temperature and the maximum temperature differential ΔT is recorded in advance in the controlling portion 44. The controlling portion 44 determines the maximum temperature differential ΔT from the outside air temperature based on this relationship that is known in advance. In this way, it is possible to control the CRAC more appropriately through varying the maximum temperature differential ΔT depending on the outside air temperature.

The air-conditioner operation controlling device 4 explained in the present example can be embodied through a computer that is equipped with a CPU, a memory device, and an interface, and through a program for controlling these hardware resources. The CPU executes the processes explained in the present form of embodiment in accordance with a program that is stored in the memory device.

The present invention is applied to a technology for suppressing and controlling temperature settings so that there will be no excessive cooling in an air-conditioned space in a server room or data center.

1. An air-conditioner operation controlling device in a server room wherein is disposed a plurality of server racks containing servers and a plurality of air conditioners cooling the server racks, comprising:
an air conditioner load calculator calculating air-conditioning loads for zones that handle the individual air-conditioners, based on the electric current values of the individual server racks;
a controller controlling the individual air-conditioners through calculating, from the air-conditioning load and the maximum temperature difference between the return air temperature and the supply air temperature for each individual air-conditioner, a return air temperature setting value, for each individual air-conditioner, such that the supply air temperature is no less than a specific temperature for the individual air-conditioner, and outputting the return air temperature setting values to the individual air-conditioners.

2. The air-conditioner operation controlling device as set forth in claim 1, further comprising:
an outside air temperature acquiring device acquiring information on an outside air temperature; wherein:
the controller determines a maximum air temperature differential depending on the outside air temperature when calculating the return air temperature setting value for an individual air-conditioner.

3. An air-conditioner operation controlling method in a server room wherein is disposed a plurality of server racks containing servers and a plurality of air conditioners cooling the server racks, comprising:
a conditioner load calculating step calculating air-conditioning loads for zones that handle the individual air-conditioners, based on the electric current values of the individual server racks; and
a controlling step controlling the individual air-conditioners through calculating, from the air-conditioning load and the maximum temperature difference between the return air temperature and the supply air temperature for each individual air-conditioner, a return air temperature setting value, for each individual air-conditioner, such that the supply air temperature is no less than a specific temperature for the individual air-conditioner, and outputting the return air temperature setting values to the individual air-conditioners.

4. The air-conditioner operation controlling method as set forth in claim 3, further comprising:
an outside air temperature acquiring step acquiring outside air temperature information, prior to the controlling step; wherein:
the controlling step determines a maximum air temperature differential depending on the outside air temperature when calculating the return air temperature setting value for an individual air-conditioner.
